(19) United States
(12) Patent Application Publication
(10) Pub. No.: US 2010/0175340 A1
(43) Pub. Date: Jul. 15, 2010

(54) THERMAL INSULATION ELEMENT WITH VENTILATION DUCTS

(75) Inventor: Gerd Hauser, Graefelfing (DE)

Correspondence Address: GREENBLUM & BERNSTEIN, P.L.C., 1950 ROLAND CLARKE PLACE, RESTON, VA, 20191, US

(73) Assignee: HRAUNHOFER-GESELLSCHAFT ZUR FOERDERUNG DER ANGEWANDTEN-ORSCHUNG E.V., Muenchen (DE)

(21) Appl. No.: 12/601,988

(22) PCT Filed: Jun. 2, 2008
(86) PCT No.: PCT/EP2008/004372

§ 371 Date: Nov. 25, 2009

(30) Foreign Application Priority Data
May 31, 2007 (DE) 10 2007 025 469.7

(51) Int. Cl. E04B 1/76; B23P 17/00; E04C 2/52

(52) U.S. Cl. 52/220.1; 29/897

(57) ABSTRACT

An element (2) is presented, in particular a plate-like element, for the thermal insulation of a building, which element is provided for attachment to an exterior wall (1) of a building on the outside. The element (2) thereby has ducts (3), which can be used as ventilation ducts. The ducts (3) are surrounded by the element (3) on all sides apart from in edge areas. The element (2) is characterized in that the ducts (3) extend in individual areas of the element (2) to an edge of the element (2) such that when the element (2) is attached to the exterior wall (1) at desired locations connections (4) of the ducts to the exterior wall (1) are formed, through which air can flow into the building or can be guided out of the building.

### TECHNICAL FIELD

The invention relates to an element for the thermal insulation of a building.

### PRIOR ART

In many cases the thermal insulation of a building is carried out by attaching thermal insulation elements to the exterior wall of the building. This can also often be carried out by retrofitting. The thermotechnical improvement of exterior walls is thus generally carried out with composite thermal insulation systems which have a thermal insulation in the form of polystyrene rigid-foam panels attached to the exterior wall on the outside. In the course of the thermotechnical improvement of a building, it is often useful not only to improve the insulation of the walls, but also to provide a controlled ventilation. Central ventilation systems necessary for this purpose often cannot be realized in existing buildings due to the low ceiling heights usually available and the enormous space requirements for ventilation ducts. The ventilation heat losses thus cannot be reduced as efficiently as transmission heat losses. It makes sense to carry out a retrofitting accommodation of ventilation systems only in buildings with high floor-to-floor heights. In this case suspended ceilings are installed, in which the ventilation ducts are accommodated. In buildings constructed after the second world war, the floor-to-floor heights are generally not sufficient for retrofitting suspended ceilings. In this case it has hitherto been possible only to realize decentralized systems that render possible a room-by-room supply with fresh air. However, the heat exchanger efficiency of systems of this type is much lower than the efficiency of central systems. The ventilation efficiency is also lower. Decentralized systems of this type are also expensive. The reason for this, among other things, is that a large number of fans are necessary. One starting point that is suitable in particular for retrofitting central ventilation systems is the accommodation of ventilation ducts in the exterior insulation. If thermal insulation is attached to the outside of the exterior wall in the course of the thermotechnical improvement of a building, ventilation ducts for a central ventilation system can be accommodated therein. To this end metallic spiral pipes are inserted into recesses made on-site in the exterior insulation at scattered intervals. For the interior area of buildings, ventilation ducts of rigid polystyrene foam are available with circular internal cross section and square external cross section. Suitably produced exterior insulation panels with integrated ventilation ducts and required sound-proofing properties do not exist as yet. A thermal insulation is known from JP 2004-060288 A2, which in individual areas has a hollow duct, through which air necessary for the ventilation can flow. This hollow duct is formed in that the generally thicker thermal insulation is composed of only a thin metal insulator in selected areas. The insulation element is therefore thinner in this area. When the insulation element is attached to the exterior wall, the said ventilation duct is formed between the metal insulation and the exterior wall.

DE 36 18 457 discloses a heat-insulating façade with an insulating layer, which is composed of insulating panels, arranged on the outside of the structure wall to be protected. A covering layer, in particular a plaster layer, is used to cover towards the outside. Ducts are provided in the insulating panels, which ducts run one next to the other in an approximately perpendicular or oblique manner and thereby follow the surface extension of the insulating layer. The ends of the ducts are open to the surroundings. The ducts are used to carry away undesirable moisture from the insulation. The resulting duct system does not have any connection to the interior of the building.

### SPECIFICATION

The object of the present invention is to disclose an improved system for the thermal insulation and ventilation of a building. To this end, in particular a plate-like element is proposed for the thermal insulation of a building, which element is provided for attachment to an exterior wall of a building, wherein the element has ducts that can be used as ventilation ducts. As a rule, this will be a plate-like element that is to be attached to a flat wall. However, the element can also be round, for example, if it has to be attached to a round wall. The element is characterized in that the ducts, apart from edge areas, are surrounded by the element on all sides. That means that the ducts are located inside the elements and not at the edge. Consequently, the ducts are not partially delimited by the exterior wall. Of course, the element cannot surround the ducts on all sides in the edge areas. Instead, the ducts running through the element are open at the end of an element, so that air can flow from one element into the adjacent element. In individual areas of the element the ducts extend towards an edge of the element such that, when the element is attached to the exterior wall, connections of the ducts to the exterior wall are formed at desired locations. These are the locations at which the air is to be guided into the building or out of the building. A connection of the ducts to the exterior wall is unavoidable at these locations, despite the aforementioned disadvantages. This type of arrangement of the ducts has several advantages. If the ducts, as known in the prior art, are partially surrounded by the exterior wall, the sound present in the ventilation ducts is transferred through the exterior wall into the interior of the building. This is obviously unpleasant for the residents or users of the building. The sound in the ventilation ducts can thereby either originate from flow noises or can be carried along, as it were, from the rooms to be aired or ventilated. Furthermore, gases or gas mixtures with an unpleasant odor can escape from the exterior wall, in particular in the case of a newly built exterior wall. If the ventilation duct were connected directly to the exterior wall, these gases or gas mixtures with an unpleasant odor would be able to reach the inlet air in a higher concentration. The aforementioned disadvantages are avoided with the plate-like element according to the invention in a simple manner.

A particularly preferred embodiment provides that the element can be obtained in that the duct is formed by the removal of insulating material during the production of the one-piece element, without further steps being necessary. Only enough insulating material is removed thereby so that in the area of the ducts the thermal transmission value is no more than 25% higher, preferably no more than 20% higher, than in the remaining area of the plate-like construction element. The duct is thus provided in a very simple manner. Correspondingly prefabricated elements are produced, which can be processed at the building site even by personnel without special training. Through the limited increase of the thermal transmission value, the formation of undesirable thermal bridges is largely avoided. The insulating material conventionally used is thick enough that the increase in the thermal transmission value through the removal of insulating material in the areas in which the desired ventilation ducts are to be arranged remains within the cited, reasonable limits.

A suitable building material for the plate-like element is a polystyrene rigid-foam panel. Polystyrene rigid-foam panels of this type are known as thermal insulation elements and have good properties for thermal insulation and sound-proofing. Moreover, they are easily workable.

A particularly simple and thus inexpensive method for forming the duct is to cut out the insulating material with a hot wire. This has been tried and tested in practice in particular with polystyrene rigid-foam panels. This is a relatively cost-effective method which is known in the prior art.

In order to improve the desired sound-proofing and sound damping, the walls of the ducts can be embodied in a sound-proofing and/or sound damping manner. To this end it is possible, for example, to provide holes with a diameter of 1 to 2 mm and a depth of approx. 10 to 12 mm in the insulating material starting from the duct walls. A micro-perforated absorber is thus created, which is known to act in a sound-damping manner.

In order on the one hand to achieve a sufficiently large cross section of the duct, which renders possible the desired flow through, and on the other hand to limit the increase in the thermal transmission value, it is expedient if the duct is essentially rectangular, wherein the width of the duct is approx. 10 times as large as the depth. Of course, a precisely rectangular form is not important here. The important factor is only that the depth of the duct determines the increase in the thermal transmission value in the region of the duct. In order to optimize the thermal properties of the duct overall, it is more favorable if the thermal transmission value is somewhat increased in wider regions than having to tolerate a clear increase in smaller areas. It is therefore more favorable to embody the ducts to be much wider than deep. A favorable measurement for the width of the duct is approx. 30 cm. If the given ratio of width and depth is followed, this would correspond to a depth of approx. 3 cm.

If it should prove easier to produce a duct with an approximately circular cross section for reasons of production engineering, this is to be accepted, despite the above-mentioned advantages of approximately rectangular ducts that are much wider than deep. In any case, the thickness of the element should be at least 10 cm. This ensures that the thermal transmission value is also sufficiently low in the region in which the ducts are located.

The element preferably has connection devices, which are arranged such that several elements can be connected such that a desired duct system is produced. In particular, the elements can have recesses and mating parts matched thereto, such as corresponding tongues and grooves on the edges, so that even non-specialized staff will interconnect the elements in an appropriate manner. Errors in assembly can thus be avoided.

A thermal insulation system for a building can thus be produced with a plurality of the above-mentioned elements. Openings are to be made for this purpose in the exterior wall of the building, which openings connect the interior of the building to the duct system, through which the air flows into the plate-like elements. The ducts in the plate-like elements form precisely this duct system.

If the openings in the exterior wall are embodied so as to be closeable, this means that the ventilation can be controlled as required for individual rooms.

The production of an above-mentioned element requires little expenditure. The elements can be produced simply, for example, in that the ducts are formed by removing insulating material from a one-piece element. As already mentioned, a commercially available polystyrene rigid foam panel can be used, from which the insulating material can be easily removed with a hot wire.

### EXEMPLARY EMBODIMENT

Without restricting generality, the invention is described below based on an exemplary embodiment.

They show

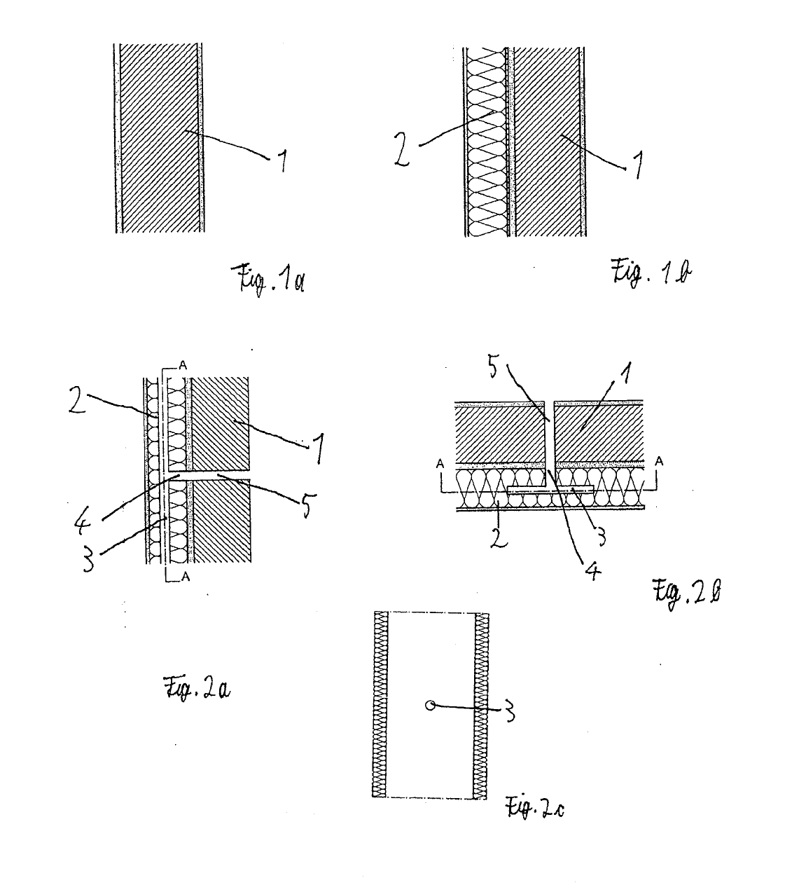

FIG. 1a: An existing exterior wall according to the prior art

FIG. 1b: An exterior wall thermotechnically improved according to the prior art

FIG. 2a: A vertical section of an improved exterior wall with ventilation ducts

FIG. 2b: A horizontal section of an improved exterior wall with ventilation ducts

FIG. 2c: A further section of an improved exterior wall with ventilation ducts

FIG. 1a shows an existing exterior wall 1, as is known and widespread in the prior art. If one wants to improve the often poor thermal insulation, a thermally insulating element 2 of a polystyrene rigid-foam panel that is at least 10 cm thick can be attached to the outside, as shown in FIG. 1b. In FIG. 2a a thermotechnically improved exterior wall 1 with a ventilation duct 3 is shown in vertical section. It is discernible that the ventilation duct 3 is located in the center of the thermally insulating element 2 and expands from the bottom upwards. At selected locations 4 the ventilation duct extends up to the edge of the rigid foam panel. At these locations 4 the exterior wall has an opening 5, so that the air from the ventilation duct 3 can flow into the respective room of the building or accordingly can flow out of the room. FIG. 2b shows a vertical section so that the width of the ventilation duct 3 is discernible. The further section in FIG. 2c shows that the ventilation ducts 3 have a circular cross section.

### LIST OF REFERENCE NUMBERS

1 Exterior wall
2 Thermally insulating element
3 Ventilation duct
4 Extensions
5 Exterior wall openings

1. Element, in particular a plate-like element, for the thermal insulation of a building, which element is provided for attachment to an exterior wall (1) of a building on the outside, wherein the element (2) has ducts (3) that can be used as ventilation ducts and are surrounded by the element (2) on all sides apart from in edge areas, characterized in that in individual areas of the element (2) the ducts (3) extend towards an edge of the element (2) such that, when the element (2) is attached to the exterior wall, connections (4) of the ducts to the exterior wall are formed at desired locations, through which air can be guided into the building or out of the building.

2. Element according to claim 1, characterized in that the element (2) can be obtained in that the duct (3) is formed by the removal of insulating material during the production of the one-piece element (2), without further steps being necessary.

3. Element according to claim 1, characterized in that in the area of the ducts (3) the thermal transmission value is no more than 25% higher, preferably no more than 20% higher, than in the remaining area of the element (2).

4. Element according to claim 1, characterized in that the element (2) is a polystyrene rigid-foam panel.

5. Element according to claim 2, characterized in that the duct (3) can be obtained by cutting out the insulating material with a hot wire.

6. Element according to claim 1, characterized in that the walls of the ducts (3) are embodied in a sound-proofing and/or sound damping manner.

7. Element according to claim 1, characterized in that the ducts (3) are essentially rectangular, wherein the width of the ducts (3) is approx. 10 times as large as the depth.

8. Element according to claim 1, characterized in that the width of the ducts (3) is approximately 30 cm.

9. Element according to claim 1, characterized in that the ducts (3) have an approximately circular cross section.

10. Element according to claim 1, characterized in that the thickness of the element (2) is at least 10 cm.

11. Element according to claim 1, characterized in that connection devices, in particular recesses and mating parts matched thereto, are present which are arranged such that several elements (2) can be connected such that a desired duct system is produced.

12. Thermal insulation system for a building formed from a plurality of elements (2) according to claim 1, wherein openings (5) in the exterior wall (1) of the building are present, which openings connect the interior of the building to the duct system, which is formed by the ducts (3) in the elements (2).

13. Thermal insulation system according to claim 12, characterized in that the openings (5) in the exterior wall (1) can be closed.

14. Method for producing an element according to claim 1, characterized in that the ducts (3) are formed by removing insulating material from a one-piece insulation element, in particular a one-piece insulation panel.
